(19) United States
(12) Patent Application Publication
(10) Pub. No.: US 2025/0337230 A1
(43) Pub. Date: Oct. 30, 2025

(54) ELECTRICAL CONDUCTOR SPLICE DEVICES

(71) Applicant: Hubbell Incorporated, Shelton, CT (US)

(72) Inventor: Pieter Jere Beckman, Nottingham, NH (US)

(73) Assignee: Hubbell Incorporated, Shelton, CT (US)

(21) Appl. No.: 19/188,274

(22) Filed: Apr. 24, 2025

Related U.S. Application Data
(60) Provisional application No. 63/637,997, filed on Apr. 24, 2024.

(51) Int. Cl. H02G 15/10; H02G 1/14

(52) U.S. Cl. CPC H02G 15/10; H02G 1/14

(57) ABSTRACT

A splice device is provided that can include a first and second housing body, a first and second set of jaws, a biasing element and a tightening element. The first and second set of jaws is in the first and second housing body and depends outward along a conductor axis. The first and second set of jaws receive a first and second electrical conductor therein respectively. The tightening element of the splice device is operatively associated with the first and second set of jaws so that a tightening movement of the tightening element is converted into a clamping force of the first and second set of jaws on the first and second electrical conductors.

### CROSS REFERENCE TO RELATED APPLICATIONS

This application claims the benefit of U.S. Provisional Application 63/637,997 filed Apr. 24, 2024, the contents of which are incorporated herein in their entirety.

### BACKGROUND

### 1. Field of the Invention

The present disclosure is related to splice devices for electrical conductors. More particularly, the present disclosure is related to splice devices that quickly connect electrical conductors of the same or different outer diameter, without the need for special tools.

### 2. Description of Related Art

Automatic splice devices are known and have been found to be an economically attractive option for splicing electrical conductors. These automatic splice devices allow for connection of electrical conductors automatically, namely without the use of specialized tools. An example of such an automatic splice device is shown in Applicant's own U.S. Pat. No. 10,498,052.

However, such automatic splice devices can only make reliable electrical connections where there is a predetermined minimum amount of tension on the conductors at all times. Simply stated, automatic splice devices cannot be used in “slack-span” applications—where little or no tension is applied to the conductors being joined. Moreover, automatic splice devices cannot reliably be used in applications where the predetermined minimum tension cannot be maintained due to vibration, wind, or other tension relieving conditions.

Accordingly, it has been determined by the present application there is a need for electrical conductor splicing devices that overcome, alleviate, and/or mitigate one or more of the aforementioned and other deleterious effects of the prior art.

### SUMMARY

A splice device is provided that includes two housing bodies, a first and second set of jaw subassemblies, a biasing element, and a tightening element. The first set of jaws is placed in the first housing body and depend outward along a conductor axis, due to the biasing element. The first set of jaws receive a first electrical conductor therein. The second set of jaws is placed in the second housing body and depend outward along a conductor axis, due to the biasing element. The second set of jaws receive a second electrical conductor therein. The splice device imparts a clamping force on the first and second electrical conductors to mechanically and electrically connect the first and second electrical conductors, respectively.

The biasing element is retained around tail ends of both the first and second set of jaw subassemblies and is retained within both the first and second set of housing bodies. The first and second set of housing bodies contains both sets of jaw subassemblies and the biasing element within an internal cavity created when the first and second housing bodies are interlocked together. The first and second housing bodies each have a thread wrapped around an outer tail portion thereof, that threadably engages the tightening element which can be a torque limited nut. The biasing element provides an initial clamping force when the first and second electrical conductor are received by the first and second jaws, and the tightening element is operatively associated with the first and second set of jaw subassemblies so that a tightening movement of the element is converted into a clamping force of the first and second set of jaws on the first and second electrical conductors.

In some embodiments either alone or together with any one or more of the aforementioned and/or after-mentioned embodiments, the splice device further includes a dead-end depending from, or connected to either the first or second housing body.

In some embodiments either alone or together with any one or more of the aforementioned and/or after-mentioned embodiments, the splice device further includes space between the first jaw and an internal cavity of the first housing body, and space between the second jaw and the second housing body. The spacing within the internal cavity allows first and second set of jaw subassemblies to move along the conductor axis within the housing bodies, during the tightening movement of the driver so as to accommodate differences in diameter of the first electrical conductor. The space also allows the jaws to be pushed into the housing body, when an electrical conductor is received, overcoming the biasing force of the biasing element. When the jaws are pushed into the housing body, the clamping force of the jaws decrease to allow an electrical conductor having a variable diameter, to be accepted between the jaws. Then the biasing elements pushes the jaws back outward to increase the clamping force of the jaws to hold the electrical conductor in place before the tightening element is used for further tightening.

A splice device is provided that has first and second housing bodies that each have an inner surface that interact with an outer surface of the first and second set of jaw subassemblies, respectively, to convert the linear outward movement of the first and second set of jaws into a linear downward movement perpendicular to the conductor axis to impart a clamping force on the first and second electrical conductors to mechanically and electrically connect the first and second electrical conductors, respectively.

In some embodiments either alone or together with any one or more of the aforementioned and/or after-mentioned embodiments, the first and second set of jaw subassemblies move along the conductor axis during the tightening movement of the tightening element so as to accommodate differences in diameter of the first and second electrical conductors.

In some embodiments either alone or together with any one or more of the aforementioned and/or after-mentioned embodiments, the first and second set of jaw subassemblies move along the conductor axis independent of one another or in unison.

In some embodiments either alone or together with any one or more of the aforementioned and/or after-mentioned embodiments, the splice device mechanically and electrically connects the first and second conductors when the first and second conductors have a common outer diameter or different outer diameters.

In some embodiments either alone or together with any one or more of the aforementioned and/or after-mentioned embodiments, the splice device mechanically and electrically connects the first and second conductors when the first and second conductors are under tension.

In some embodiments either alone or together with any one or more of the aforementioned and/or after-mentioned embodiments, the splice device mechanically and electrically connect the first and second conductors when the first and second conductors are not under tension.

In some embodiments either alone or together with any one or more of the aforementioned and/or after-mentioned embodiments, the tightening element further includes a torque limiting area or break away web that breaks or shears off a portion of the tightening element at a desired torque to ensure the clamping force has been applied to the first and second electrical conductors.

In some embodiments either alone or together with any one or more of the aforementioned and/or after-mentioned embodiments, the first set of jaws have a first conductor stop that provides a tactile indication of a position of the first electrical conductor within the first set of jaws and/or the second set of jaws have a second conductor stop that provides a tactile indication of a position of the second electrical conductor within the second set of jaws.

In some embodiments either alone or together with any one or more of the aforementioned and/or after-mentioned embodiments, first and/or the second housing body have at least one vent slot that provides an opening from the interior of the housing body to the exterior of the housing body, so as to release accumulated moisture, thereby mitigating corrosion. In some embodiments where more than one vent slot is present on the housing body, the vent slots are positioned equidistant from each other around the perimeter of each housing body. In some embodiments four vent slots are present on each of the first and second housing bodies.

The above-described and other features and advantages of the present disclosure will be appreciated and understood by those skilled in the art from the following detailed description, drawings, and appended clauses.

### BRIEF DESCRIPTION OF THE DRAWINGS

FIG. 1 is a top perspective view of an exemplary embodiment of an electrical conductor splice device in an open position according to the present disclosure;

FIG. 2 is an exploded assembly showing the individual parts of the device of FIG. 1;

FIG. 3 is a perspective view of a jaw subassembly of the device of FIG. 1;

FIG. 4 is a perspective view of the jaw subassembly of the device of FIG. 1;

FIG. 5 is a perspective view of the jaw subassembly of the device of FIG. 4 in a partially assembled state;

FIG. 6 is a perspective view of housing bodies of FIG. 1;

FIG. 7 is a perspective view of the housing body of FIG. 6 and the jaw subassembly of FIG. 4 in a partially assembled state;

FIG. 8 is a perspective view of the device of FIG. 1 in another partially assembled state;

FIG. 9 is a perspective view of a tightening element of the device of FIG. 1;

FIG. 10 is a front view of the splice device of FIG. 1;

FIG. 11 is a sectional view of the device of FIG. 1, in an open position before the installation of electrical conductors;

FIG. 12 is a sectional view of the device of FIG. 1, in an open position after inserting electrical conductors;

FIG. 13 is a perspective view of the device of FIG. 1, in a closed position after installation of electrical conductors;

FIG. 14 is a front view of the splice device of FIG. 13;

FIG. 15 is a sectional view of the device of FIG. 13, in a closed position after installation on electrical conductors;

FIG. 16 is a top perspective view of an alternate exemplary embodiment of an electrical conductor splice device, in an open position according to the present disclosure;

FIG. 17 is side view of the device of FIG. 16;

FIG. 18 is a sectional view of the device of FIG. 16, before installation on electrical conductors;

FIG. 19 is a top perspective view of a housing body as shown in FIG. 16;

FIG. 20 is a side view of the housing body as shown in FIG. 19;

FIG. 21 is a top view of the housing body as shown in FIG. 19;

FIG. 22 is a top perspective view of a jaw portion of the device of FIG. 16;

FIG. 23 is a bottom perspective view of a jaw portion of the device of FIG. 16; and

FIG. 24 is a perspective view of a jaw subassembly of the device of FIG. 16.

FIG. 25 is a top perspective view of another alternate exemplary embodiment of an electrical conductor splice device according to the present disclosure; and

FIG. 26 is a sectional view of the device of FIG. 25, before installation on electrical conductors.

### DETAILED DESCRIPTION

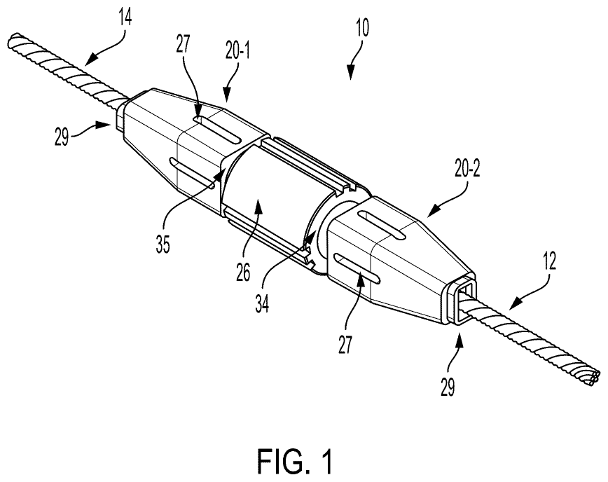

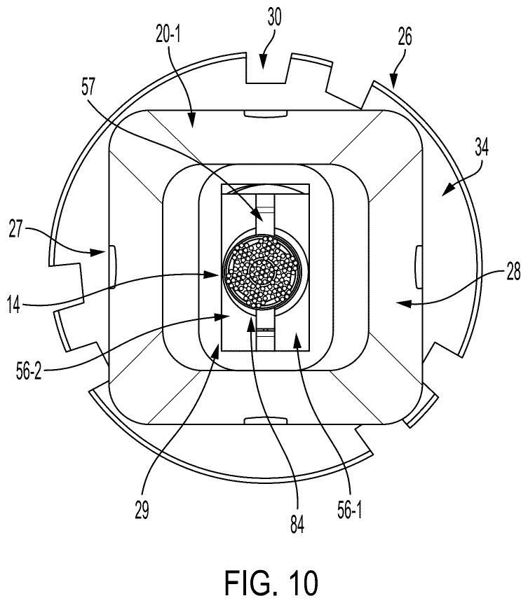

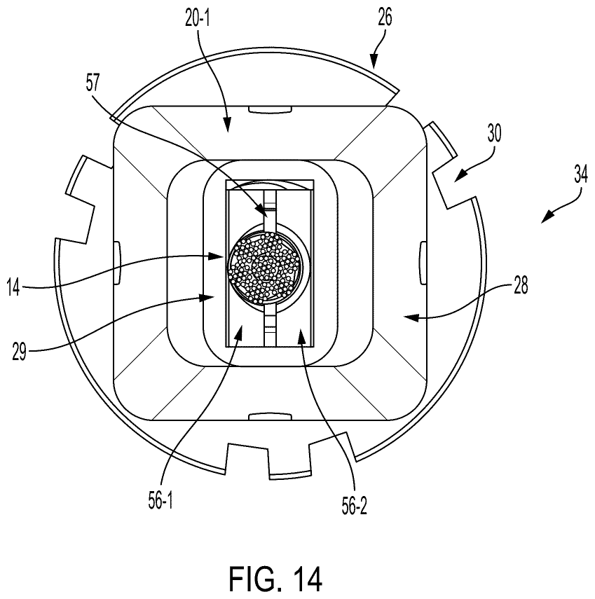

Referring to the drawings and in particular to FIGS. 1-15, an exemplary embodiment of an electrical conductor splice device according to the present disclosure is shown and is generally referred to by reference numeral 10.

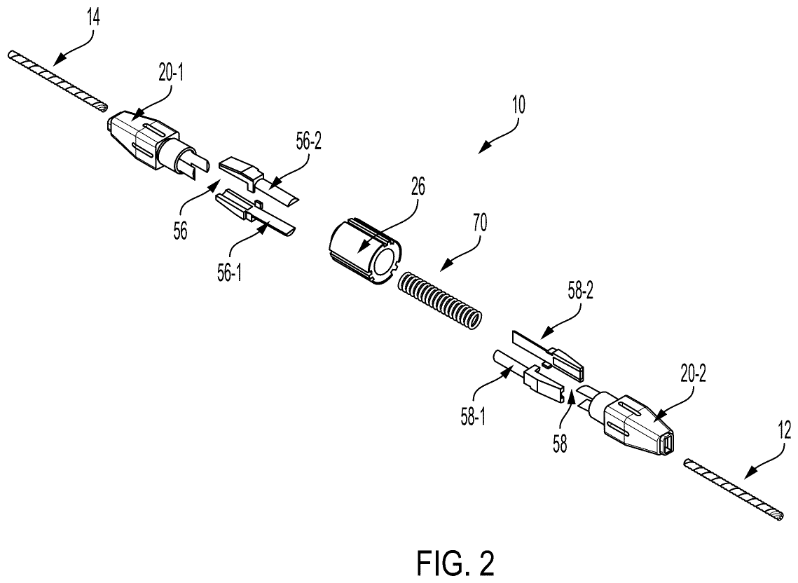

Advantageously, and referring to FIGS. 1 and 2, device 10 can be used to mechanically and electrically connect conductors 12, 14 that are under tension or that have little or no tension applied to the conductors-so called slack-span conductors. Device 10 can be installed on electrical conductors 12, 14 first using hand tightening, and then using common tightening tools to fully tighten the device such as, but not limited to, open-end wrenches, spanner wrenches and adjustable wrenches.

Moreover and in some embodiments, device 10 can be configured to self-adjust to connect electrical conductors 12, 14 of different sizes (i.e., outer diameter or OD). In this manner, device 10 can be configured for electrical conductor reducing applications.

Device 10 is now described with simultaneous reference to FIGS. 1-15. Device 10 has a first and second housing body 20-1 and 20-2 that, when threadably connected, protrude outward from opposing ends of the tightening element 26.

Device 10 can in some embodiments have one or more slots 27 that allow water and contamination to drain to mitigate the formation of corrosion. In some embodiments device 10 has at least one drainage slot on each housing body 20-1 and 20-2. In other embodiments device 10 has multiple drainage slots 27 on each housing body 20-1 and 20-2 that are spaced equidistant from each other on the perimeter of housing bodies 20-1 and 20-2. In some embodiments device 10 has four drainage slots on each housing body 20-1 and 20-2 that are spaced equidistant from each other.

Device 10 further includes a first jaw subassembly 56, a second jaw subassembly 58, a biasing element 70, and a tightening element 26. The jaw subassemblies 56, 58 are housed within bodies 20-1 and 20-2 respectively. In some embodiments, biasing element 70 can be a compression spring. Of course, it is contemplated by the present disclosure for biasing member 70 to be any member providing a sufficient first clamping force on the conductors and a degree of freedom to accommodate conductors of different sizes. In some embodiments, tightening element 26 can be a threadable tightening member-such as a threaded nut as shown.

Device 10 is configured to convert a tightening movement of tightening element 26 into a clamping force C_{F} on conductors 12, 14. In some embodiments, device 10, is configured with one or more degrees of freedom sufficient to accommodate conductors 12 and 14 of differing outer diameters. In still other embodiments, jaw subassemblies 56, 58, along with biasing element 70, and first and second housing bodies 20-1, 20-2 are configured to hold conductors 12 and 14 in position during the tightening movement of the tightening element 26.

Each jaw subassembly 56, 58 is defined by a pair of jaw elements 56-1, 56-2, and 58-1, 58-2, respectively. In some embodiments, jaw elements 56-1, 56-2, 58-1, 58-2 all have an identical shape to streamline manufacturing, while in other embodiments the jaw elements can have shapes that differ from one another.

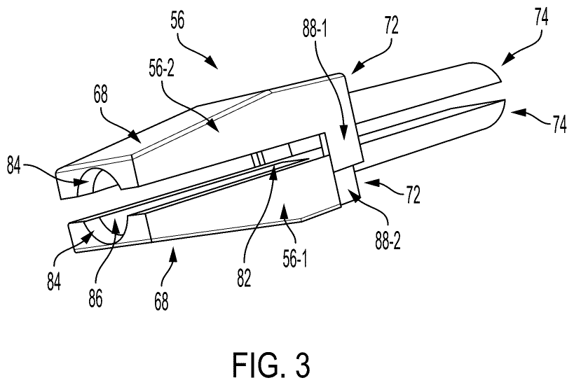

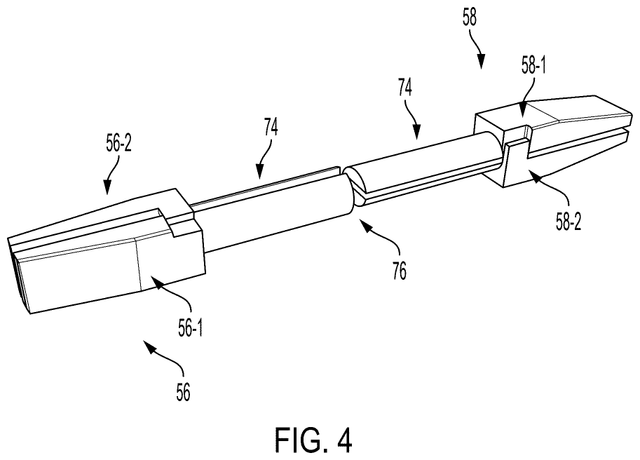

Each jaw element 56-1, 56-2, 58-1, 58-2 has an outer sloped surface 68, an interlocking protrusion 88-1, and a groove 88-2 for receiving an interlocking protrusion. Jaw subassemblies 56, 58 further include a tail protrusion portion 74, a spring landing surface 72 for interfacing with biasing element 70, and a chamfered groove 84 for guiding conductors 12 and 14 into the groove 86 and a stop 82. Jaw elements 56-1, 56-2 can be assembled to define first jaw subassembly 56, while jaw elements 58-1, 58-2 can be assembled to define second jaw subassembly 58 as shown in FIGS. 3, 4 and 5. In some embodiments, jaw subassemblies 56 and 58 are arranged tail end 74 to tail end 74, with a gap 76 therebetween, as shown in FIG. 4, with one jaw subassembly being rotated relative to the other jaw subassembly, about axis C_{A} as shown. Jaw elements 56-1, 56-2, 58-1, and 58-2 can be made of aluminum, and can be made of 6061-T6 aluminum. In some embodiments jaw elements 56-1, 56-2, 58-1, and 58-2 can be made of metals that are known to have similar mechanical and electrical properties as 6061-T6 aluminum.

Jaw subassemblies 56 and 58 are kept properly interlocked together by fitting each protrusion 88-1 into each groove 88-2, which prevents jaw elements 56-1, 56-2, 58-1 and 58-2 from moving out of alignment, particularly when external rotational force is applied to the jaws when device 10 is in use.

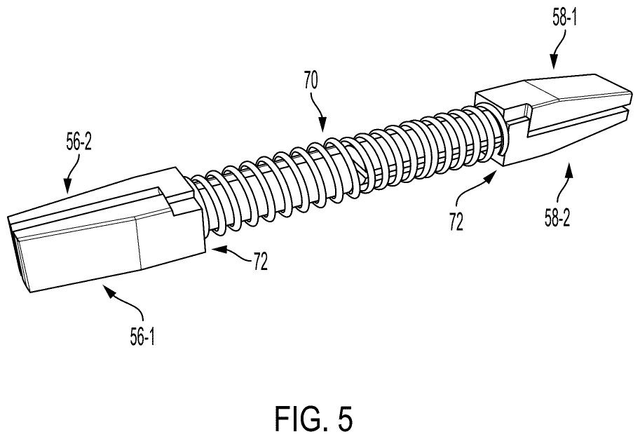

Biasing member 70 can be made of any electrically conductive or insulating material that applies a biasing force between lands 72 of both jaw subassemblies 56, 58, respectively. The biasing element 70, also maintains gap 76 between the jaw subassemblies 56, 58. In the illustrated embodiment shown in FIG. 5, biasing member 70 is shown as a compression spring that is made of a metallic material such as, but not limited to, stainless steel.

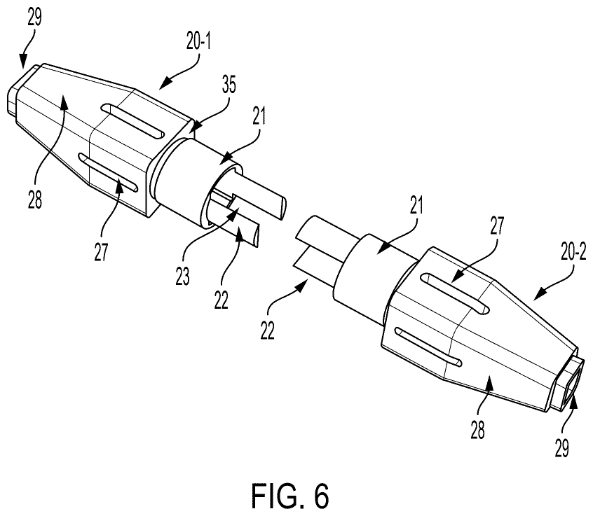

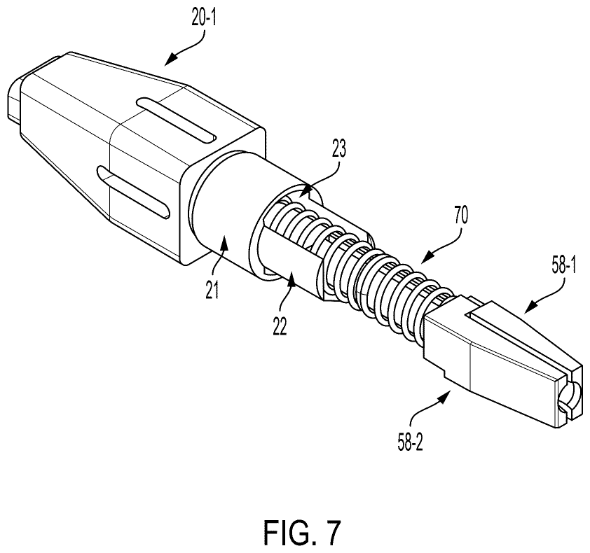

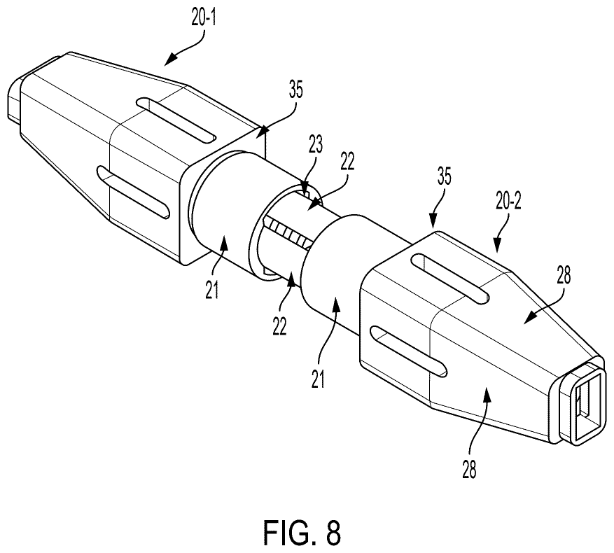

Housing bodies 20-1 and 20-2 each have openings 29 at one end for accepting electrical conductors 12 and 14, and tail protrusions 22 at the opposite end thereof. Hollow cylindrical portions 21 connect tail protrusions 22 to housing bodies 20-1 and 20-2. Hollow cylindrical portions 21 are surrounded by a thread (not shown in FIG. 8) for threadably engaging with tightening element 26. Tail protrusions 22 are separated by a gap 23, that includes empty space within cylindrical portion 21, and housing bodies 20-1 and 20-2. Tail protrusions 22 of each housing body are able to be accepted into the hollow cylindrical portion 21 of the opposite housing body via gap 23, when housing bodies 20-1 and 20-2 are rotated 90 degrees relative to each as shown in FIGS. 6 and 8. Each housing body 20-1 and 20-2 has multiple sloped outer surfaces 28 that cause the housing bodies to narrow from a wider section adjacent slots 27 towards a narrower section adjacent opening 29. Space 23 accommodates and accepts jaw subassemblies 56, 58 and biasing element 70 as shown in FIG. 7.

In some embodiments, housing bodies 20-1, 20-2 can have an identical shape to streamline manufacturing, while in other embodiments the bodies can have different shapes. Housing bodies 20-1 and 20-2 can be made of aluminum and can be made of 6061-T6 aluminum. In some embodiments Housing bodies 20-1 and 20-2 can be made of metals that are known to have similar mechanical and electrical properties as 6061-T6 aluminum.

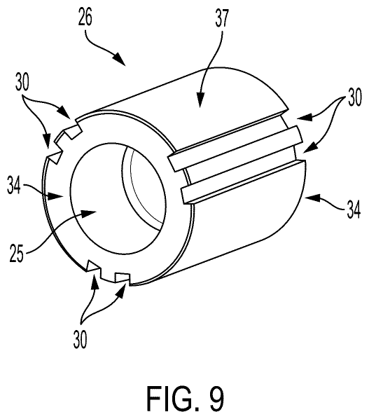

In some embodiments and referring to FIG. 9, tightening element 26 includes a torque limiting area or areas 30 that shears off element 26 once an appropriate level of torque and, thus clamping force, has been applied to device 10. In some embodiments areas 30 can also be grooves used to help interface with a tool for tightening the element 26. In some embodiments tightening element 26 is a nut that has a unique break away web which shears off element 26 once an appropriate level of torque and, thus clamping force, has been applied to device 10.

Tightening element 26 is threadably engaged with housing bodies 20-1 and 20-2. Thus, device 10 is configured so that the housing bodies 20-1 and 20-2 are drawn axially inwards with the tightening or rotating motion of element 26.

Referring to FIG. 9 an embodiment of the tightening element 26 is shown, as a nut. Nut 26 can be cylindrically shaped, with an outer surface 37 and an inner surface 25. Inner surface 25 has threads (not shown) to threadbly engage with the threads on housing bodies 20-1 and 20-2. Element 26 has grooves 30 that provide an interface for a tightening tool such as a wrench to grasp. Element 26 has two flat faces 34 that can interact with flat faces 35 on housing bodies 20-1 and 20-2. In some embodiments element 26 is made of aluminum and can be made of 6061-T6 aluminum. In some embodiments element 26 can be made of metals that are known to have similar mechanical and electrical properties as 6061-T6 aluminum.

Electrical conductor wires 12 and 14 are inserted into device 10 through openings 29. FIGS. 1 and 10-12, show device 10 in an open position, prior to tightening of element 26, with a gap between face 35 of the housing body and face 34 of the element 26.

Electrical conductor 14 is clamped by and held in position by jaw elements 56-1, 56-2, due to the biasing element 70 holding it in place, before element 26 is tightened. Gap 57 between jaws elements 56-1, 56-2 is shown not at its smallest size as element 26 has not been not tightened.

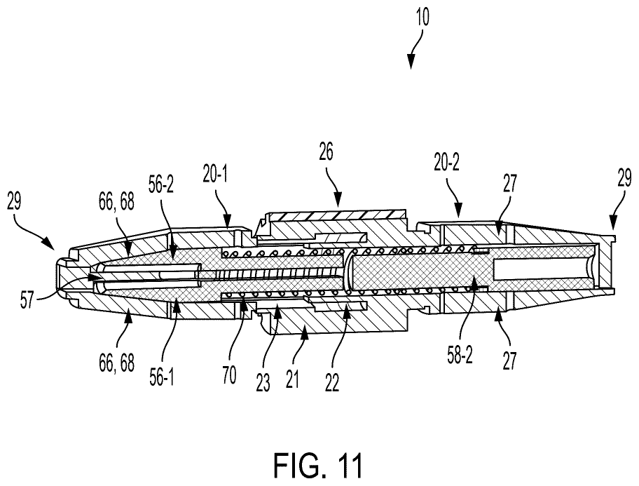

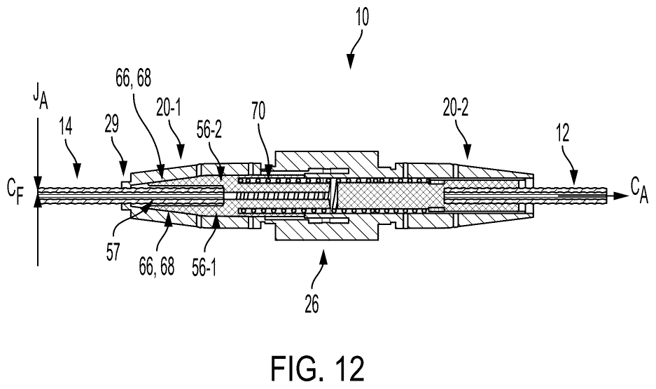

Referring to FIG. 11, a sectional view of device 10 is shown. Housing bodies 20-1 and 20-2 interlock together by fitting the opposite housing body's protrusions 22 in gap 23 of each cylindrical portion 21. In FIGS. 1, 10, 11 and 12, tightening element 26 has not yet been tightened, and therefore a gap between housing bodies 20-1 and 20-2 and faces 34 and 35 can be seen. FIG. 12 shows a section view of FIG. 1, with electrical conductors 12 and 14 being held by device 10.

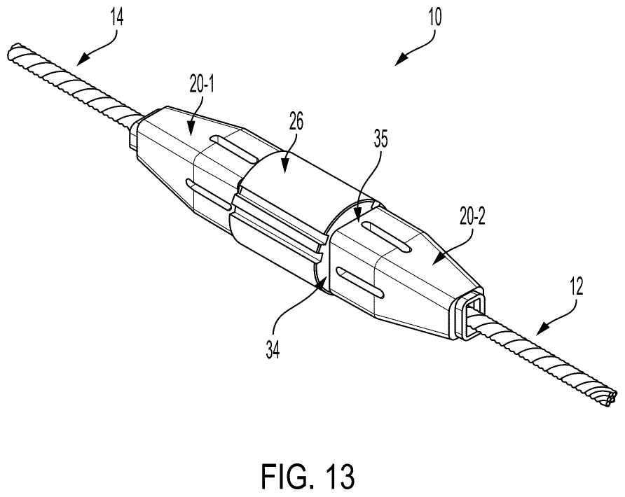

FIGS. 13, 14 and 15, show device 10, after tightening of element 26, without a gap between face 35 of the housing body and face 34 of the element 26. In some instances, depending on the diameter of the electrical conductors 12 and 14, a slight gap between face 34 and 35 may still be present after element 26 is fully tightened.

Electrical conductor 14 is clamped by and held in position by jaw elements 56-1, 56-2, due to the biasing element 70 holding it in place, and due to element 26 being tightened. Gap 57 between jaw elements 56-1, 56-2 is at a smallest size as element 26 is tightened.

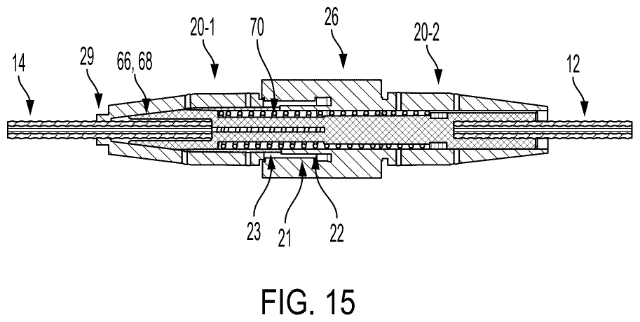

Referring to FIG. 15, a sectional view of FIG. 1 is shown. Housing bodies 20-1 and 20-2 interlock together by fitting the opposite housing body's protrusions 22 in gap 23 of each cylindrical portion 21. In FIGS. 13, 14 and 15, tightening element 26 has been tightened, and therefore there is less of a gap, or no gap between housing bodies 20-1 and 20-2 and faces 34 and 35.

Referring to FIGS. 13-15, as housing bodies 20-1 and 20-2 are drawn axially inwards and closer together, the jaw subassemblies 56, 58 have outer surfaces 68 that come into contact with inner surfaces 66 of the housing bodies 20-1 and 20-2, which cause the jaw subassemblies to tighten. Advantageously, tightening element 26 can be hand tightened after initial connection of electrical conductors 12 and 14, which allows for quick and easier connections to be made, without the use of a tool. This allows a user to concentrate on the initial connection of device 10 to the electrical conductors, without needing a tool, which can be helpful in certain environments such as those at great heights. A tool can then be used to fully tighten the tightening element 26.

Jaw subassemblies 56, 58 are configured to move linearly along conductor axis C_{A} and are retained by one or more housing bodies 20-1, 20-2 that retain the jaw subassemblies in each body respectively while allowing the jaws to move along the conductor axis C_{A}. Jaw subassemblies 56, 58 can move in unison along conductor axis C_{A} such as when conductors 12, 14 have the same outer diameter and can move independent from one another along the conductor axis C_{A} such as when conductors 12, 14 have differing outer diameters.

Housing bodies 20-1 and 20-2 each have an inner surface 66 and jaw subassemblies 56, 58 have outer surfaces 68 that interact with one another to convert the linear outward movement of the jaws along and parallel to conductor axis C_{A} into linear movement along jaw axis J_{A} that is perpendicular to axis C_{A}. The movement of jaw subassemblies 56, 58 towards conductors 12, 14 along axis J_{A} results in the jaws applying clamping force C_{F} on the conductors.

Simply stated, rotation of tightening element 26 causes housing bodies 20-1 and 20-2 to be drawn axially inwards-which in turn urges jaw subassemblies 56, 58 linearly outward-which in turn compresses the jaw elements 56-1, 56-2, 58-1, 58-2, inward, so that they clamp onto conductors 12 and 14.

Biasing member 70 is disposed between jaw subassemblies 56, 58 and around portions 74 of the jaw elements. Here, pushed surface 72 of each jaw subassembly 56, 58 defines a spring land. Tail end portions 74 of each jaw subassembly 56, 58 help retain biasing member 70 in place around jaw elements. In this position, biasing member 70 surrounds tail end portions 74, is captured against lands 72, and provides a first degree of freedom that allows device 10 to accommodate conductors 12 and 14 of differing outer diameters.

The first degree of freedom of device 10 allows for jaw elements 56-1, 56-2 in housing 20-1 to move linearly outward along conductor axis C_{A} a different distance than jaw elements 58-1, 58-2 in housing 20-2, moves for the same amount of rotation of element 26. In this manner, device 10 allows for jaw subassemblies 56, 58 to move different distances along conductor axis C_{A} depending on the outer diameter of conductors 12, 14, respectively.

It has been further found by the present disclosure that biasing member 70 can aid in assembly of conductors 12 and 14 into device 10. Here, biasing member 70 can provide an initial clamping force C_{F} on jaw subassemblies 56, 58 prior to tightening of device 10. Thus, the user only needs to install conductors 12, 14 into device 10—with biasing members 70 temporarily holding the conductors in place—while the user tightens device 10 by hand tightening element 26, and/or using a tool such as a wrench on element 26.

In some embodiments, device 10 includes gap 76 between the jaw subassemblies 56, 58 when biasing member 70 connects them together and is interfacing with spring lands 72. Gap 76 can provide a second degree of freedom that allows device 10 to accommodate conductors 12 and 14 of differing outer diameters.

The second degree of freedom of device 10 provides clearance such that jaw subassemblies 56, 58 can move within the housing bodies 20-1 and 20-2 along conductor axis C_{A} depending on the outer diameter of conductors 12, 14, respectively.

In some embodiments, the second degree of freedom results in the jaw subassemblies 56, 58 moving off center towards the smaller conductor, which ensures the jaw subassemblies move linearly outward along conductor axis C_{A} the same distance as one another.

In embodiments where device 10 includes both the first and second degrees of freedom (i.e., biasing member 70 and gap 76,) not only accommodates conductors 12, 14 of differing outer diameters but does so while balancing the clamping force C_{F} on both conductors to be substantially equal to one another.

In some embodiments, jaw elements 56-1, 56-2, 58-1, 58-2 alone or in combination with one another are configured to define a stop 82 in each leg as shown in FIG. 3. When installing conductors 12, 14 into device 10, stop 82 provides the user with a tactile indication that the conductors are properly positioned within jaw subassemblies 56, 58.

In some embodiments, jaw elements 56-1, 56-2, 58-1, 58-2 alone or in combination with one another are configured to define a chamfered edge 84 as also shown in FIG. 3. When installing conductors 12 and 14 into device 10, chamfered edge 84 provides the user with a guide that aids in insertion of the conductors into jaw subassemblies 56, 58.

In some embodiments, jaw elements 56-1, 56-2, 58-1, 58-2 alone or in combination with one another are configured to define a gripping surface 86 as shown in FIG. 3, which can have edges 86 (not shown in FIG. 3) as also shown in FIG. 23. Edge 86 can ensure that jaw subassemblies 56, 58 bite or grip into conductors 12, 14 once installed.

In some embodiments second body housing 20-2 can be configured as a dead-end (not shown), which is known in the art as being configured to form a connection between device 10 and, for example, a pole or structure. Thus, device 10, when configured with second housing body 20-2 as dead-end, can be installed at the start and/or end of a placement of an electrical conductor.

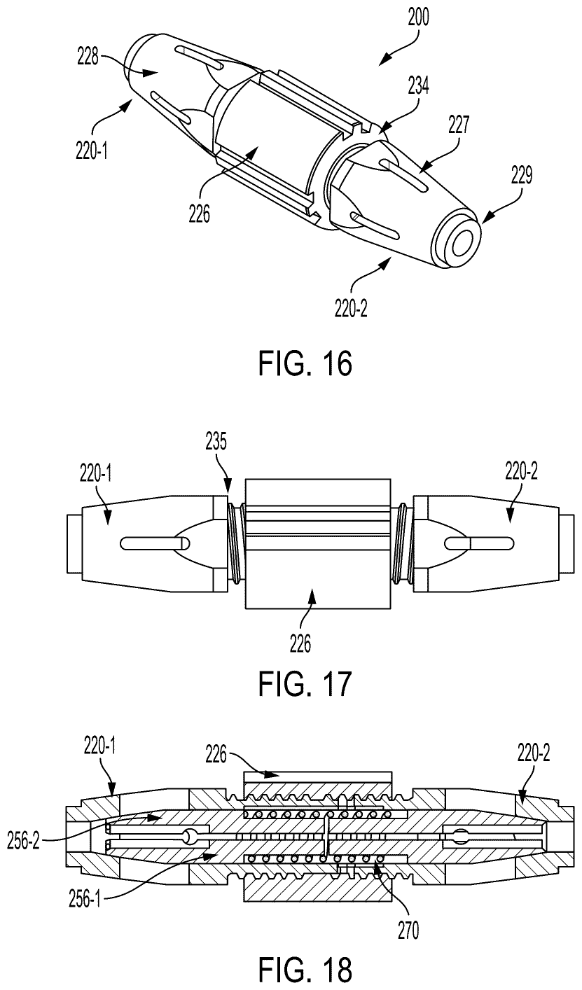

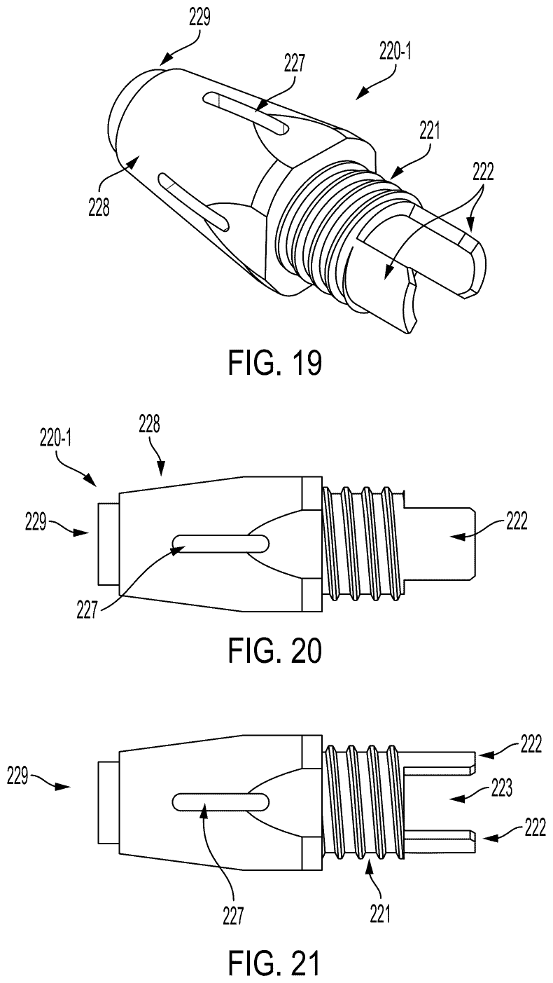

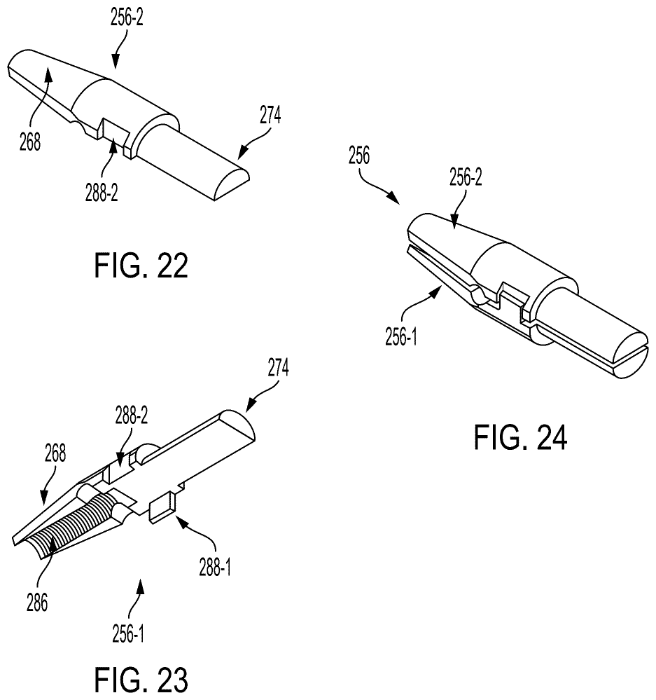

Referring now to FIGS. 16-24, an alternate embodiment of an electrical conductor splice device according to the present disclosure is shown and is generally referred to by reference numeral 200. Device 200 has a similar structure as compared to device 10 such that discussion of certain parts performing similar or analogous functions to those of device 10 have been omitted.

Device 200 is configured to electrically and mechanically connect conductors 212 and 214 (not shown) to one another. Device 200 includes first and second housing bodies 220-1 and 220-2 that are conically shaped with circular openings 229, and jaw subassemblies 256, 258.

Jaw elements 256-1 and 256-2 are joined to together to create jaw subassembly 256. Jaw elements 258-1 and 258-2 are joined to together to create jaw subassembly 258. First and second jaw assemblies 256, 258 are housed within first and second housing bodies 220-1 and 220-2. Housing bodies 220-1 and 220-2 have slots 227 for drainage. Tightening element 226 is a nut that is threadably engaged with housing bodies 220-1 and 220-2, in a similar manner as device 10 with regards to element 26 and housing bodies 20-1 and 20-2. Tightening element 226 has a flat face 234 that contacts with flat face 235 of the housing bodies when fully tightened. Device 200 includes biasing element 270, which can be a spring, to provide initial resistance when connecting electrical conductors 212, 214, and operates in the same manner as described above with regards to the biasing element 70 of device 10.

Housing bodies 220-1 and 220-2 each have an inner surface 266 and jaws 256-1, 256-2 258-1, 258-2 have an outer surface 268 that interact with one another to convert the linear outward movement of the jaws along and parallel to conductor axis C_{A} into linear movement along jaw axis J_{A} that is perpendicular to axis C_{A}. Jaw assemblies 256 and 258 are conically shaped to interface with the conical inner cavity of housing bodies 220-1 and 220-2. Referring to FIGS. 24-26, grooves 286 are in each jaw 256-1, 256-2, 258-1, 258-2, and provide greater surface area contact which enables the jaws to better grip the conductors 212 and 214. Jaws 256-1, 256-2. 258-1 and 258-2 have protrusions 288-1 that interlock into grooves 288-2 and have tail portions 274 that retain biasing element 270. Conductor axis C_{A} and jaw axis J_{A} are the same for device 200 as for device 10. The movement of jaws subassemblies 256, 258 towards conductors 212, 214 along axis J_{A} results in the jaws applying clamping force C_{F} on the conductors. Housing bodies 220-1 and 220-2 have a cylindrical hollow portion 221 with threads, and tail protrusions 222 with gap 223 therebetween. Housing bodies 220-1 and 220-2 function similarly to housing bodies 20-1 and 20-2 of device 10.

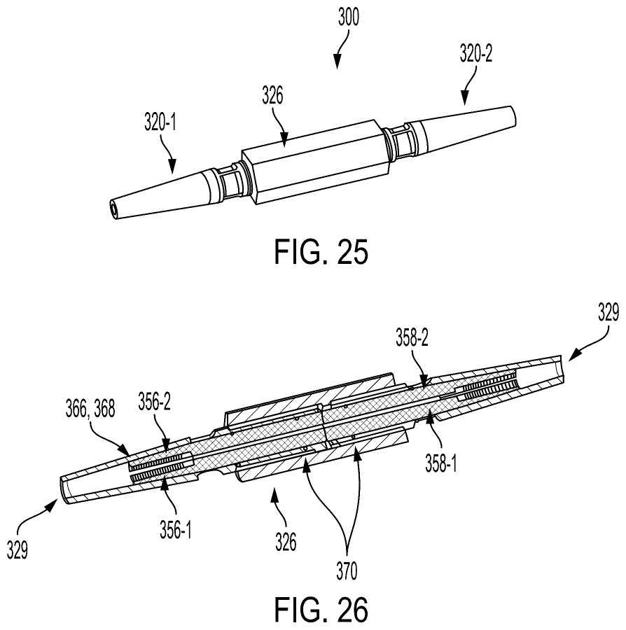

Referring now to FIGS. 25 and 26, an alternate embodiment of an electrical conductor splice device according to the present disclosure is shown and is generally referred to by reference numeral 300. Device 300 has a similar structure as compared to device 10 such that discussion of certain parts performing similar or analogous functions to those of device 10 have been omitted.

Device 300 is configured to electrically and mechanically connect conductors 312 and 314 (not shown) to one another. Device 300 includes first and second housing bodies 320-1 and 320-2 that are swaged tubes with openings 329, and jaw subassemblies 356, 358. Jaw elements 356-1 and 356-2 are joined to together to create jaw subassembly 356. Jaw elements 358-1 and 358-2 are joined to together to create jaw subassembly 358. Jaw subassemblies 356 and 358 are housed within first and second housing bodies 320-1 and 320-2. Tightening element 326 is a nut that is threadably engaged with housing bodies 320-1 and 320-2, in a similar manner as device 10 with regards to element 26 and housing bodies 20-1 and 20-2. Device 300 includes elastomeric O-rings 370 to provide initial resistance when connecting electrical conductors 312, 314, and operates in a similar manner as described above with regards to the spring of device 10.

Housing bodies 320-1 and 320-2 each have an inner surface 366 and jaws 356-1, 356-2, 358-1 and 358-2 have an outer surface 368 that interact with one another to convert the linear outward movement of the jaws along and parallel to conductor axis C_{A} into linear movement along jaw axis J_{A} that is perpendicular to axis C_{A}. Conductor axis C_{A} and jaw axis J_{A} are the same for device 300 as for device 10. The movement of jaw subassemblies 356, 358 towards conductors 312, 314 along axis J_{A} results in the jaws applying clamping force C_{F} on the conductors.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with respect to exemplary embodiments, it will be understood that various changes may be made and equivalents may be substituted for elements thereof without departing from the scope of the present disclosure. In addition, many modifications may be made to adapt a particular situation or material to the teachings of the disclosure without departing from the scope thereof. Therefore, it the present disclosure is not limited to the particular embodiment(s) disclosed as the best mode contemplated, but that the disclosure will include all embodiments falling within the scope of the appended claims.

What is claimed is:

1. An electrical conductor splice device, comprising:
a first housing body having a first externally threaded end and a second end with an opening;
a first jaw subassembly in the first housing body, the first jaw subassembly having a first jaw element and a second jaw element; and
a tightening element having a first internally threaded end, the first housing body being threadably engaged to the tightening element at the first internally and externally threaded ends,
wherein the first jaw subassembly is configured to receive a first electrical conductor therein through the opening such that a tightening movement of the tightening element is converted into a clamping force of the first and second jaw elements on the first electrical conductor.

2. The splice device of claim 1, wherein the tightening movement is rotary movement of tightening element about a conductor axis.

3. The splice device of claim 2, further comprising a biasing element configured to provide an initial clamping force on the first and second jaw elements prior to the tightening movement of the tightening element.

4. The splice device of claim 3, wherein the splice device is configured to mechanically and electrically connect the first conductor when the first conductor is tension or not under tension.

5. The splice device of claim 3, wherein the biasing element is a compression spring.

6. The splice device of claim 1, further comprising:
a second housing body having a first externally threaded end and a second end with an opening; and
a second jaw subassembly in the second housing body, the second jaw subassembly having a first jaw element and a second jaw element,
wherein tightening element has a second internally threaded end, the second housing body being threadably engaged to the tightening element at the second internally threaded end and the first externally threaded end thereof, and
wherein the second jaw subassembly is configured to receive a second electrical conductor therein through the opening such that a tightening movement of the tightening element is converted into a clamping force of the first and second jaw elements on the second electrical conductor.

7. The splice device of claim 6, wherein the splice device is configured to move the first and second jaw subassemblies along the conductor axis during the tightening movement of the tightening element so as to accommodate differences in diameter of the first and second electrical conductors.

8. The splice device of claim 7, wherein the first and second jaw subassemblies move along the conductor axis independent of one another or in unison.

9. The splice device of claim 6, further comprising a biasing element configured to provide an initial clamping force on the first and second jaw subassemblies prior to the tightening movement of the tightening element.

10. The splice device of claim 9, wherein the biasing element is a compression spring.

11. The splice device of claim 9, wherein the splice device is configured to mechanically and electrically connect the first and second conductors when the first and second conductors are under tension or not under tension.

12. The splice device of claim 6, wherein the first and second housing bodies interlock together.

13. The splice device of claim 6, wherein the first and second housing bodies are each conically shaped.

14. The splice device of claim 1, wherein the tightening element further comprises a torque limiting area that shears off at a desired torque to ensure a clamping force has been applied to the first electrical conductor.

15. The splice device of claim 1, wherein the first housing body has at least one drainage slot.

16. The splice device of claim 1, wherein the first housing body is a swaged tube.

17. A method of using a splice device comprising the steps of:
inserting a first electrical conductor into a first jaw subassembly that is in a first housing body; and
tightening a tightening element threadably connected over an end of the first housing body to convert the tightening movement into a clamping force of the first jaw subassembly on the first electrical conductor.

18. The method of claim 17, wherein the tightening is done by a hand or by a tool.

19. The method of claim 17, further comprising, prior to the tightening step, inserting a second electrical conductor into a second jaw subassembly that is in a second housing body, wherein the tightening element is threadably connected over an end of the second housing body to convert the tightening movement into a second clamping force of the second jaw subassembly on the second electrical conductor.

20. The method of claim 17, wherein the inserting step further comprises biasing the first jaw subassembly in the first housing so that an initial clamping force is provided on the first conductor prior to the tightening step.
